(19) United States
(12) Patent Application Publication
(10) Pub. No.: US 2023/0214524 A1
(43) Pub. Date: Jul. 6, 2023

(54) IMAGE PRIVACY PROTECTION METHOD AND APPARATUS

(71) Applicant: SPREADTRUM COMMUNICATIONS (SHANGHAI) CO., LTD., Shanghai (CN)

(72) Inventor: Hongkang LI, Shanghai (CN)

(21) Appl. No.: 17/854,496

(22) Filed: Jun. 30, 2022

Related U.S. Application Data
(63) Continuation of application No. PCT/CN2022/082704, filed on Mar. 24, 2022.

(30) Foreign Application Priority Data
Dec. 31, 2021 (CN) 202111679816.8

(51) Int. Cl. G06F 21/62; G06F 21/57

(52) U.S. Cl. CPC G06F 21/6245; G06F 21/57

(57) ABSTRACT

A method and apparatus for protecting image privacy are provided. The method includes identifying recorded information while a picture or a video is being taken, wherein the picture or the video includes an image; determining whether the image contains privacy information based on the recorded information; and saving the image to a storage area of Trusted Execution Environment (TEE) based on the image containing privacy information.

### CROSS-REFERENCE TO RELATED APPLICATIONS

This application is a continuation under 35 U.S.C. § 120 of PCT/CN2022/082704, filed Mar. 24, 2022, which is incorporated herein by reference, and which claimed priority to Chinese Application No. 202111679816.8, filed Dec. 31, 2021. The present application likewise claims priority under 35 U.S.C. § 119 to Japanese Application No. 202111679816.8, filed Dec. 31, 2021, the entire content of which is also incorporated herein by reference.

### TECHNICAL FIELD

The present disclosure generally relates to information security technology field, and more particularly, to a method and apparatus for protecting image privacy.

### BACKGROUND

Due to wide application of intelligent terminal devices, a large number of third-party software is always used in operating systems, and most of the software can share storage data and interfaces of the operation systems. Besides, it is difficult for users to control permission of the third-party software, especially much application software automatically uploads pictures stored in mobile phones. If there are pictures containing privacy information, such as pictures including personal information and photos of sensitive content, there will be serious privacy leakage problems after being uploaded by the application software in the mobile phones. Generally, in some scenarios, there are following risks of the user's privacy information. First, the pictures containing privacy data may be uploaded to third-party platforms or online disks, and privacy pictures are leaked from the Internet. Second, malware may look for pictures with privacy data in the operating systems and maliciously steals these pictures. Third, malware can monitor or actively trigger a shooting function to transmit pictures containing privacy information to the outside without the users being aware of it.

However, strict privacy management may greatly reduce usability of smart terminals. Too frequent privacy and permission reminders may cause users to give up their options and default to consent. In essence, this condones theft of privacy data.

### SUMMARY

Embodiments of the present disclosure provide a method and apparatus for protecting image privacy to ensure security of user privacy information.

In an embodiment of the present disclosure, a method for protecting image privacy is provided, including identifying recorded information while a picture or a video is being taken, wherein the picture or the video includes an image; determining whether the image contains privacy information based on the recorded information; and saving the image to a storage area of Trusted Execution Environment (TEE) based on the image containing privacy information.

In an embodiment of the present disclosure, a non-volatile or non-transitory computer-readable storage medium storing one or more programs is provided, the one or more programs including computer instructions, which, when executed by a processor, cause processor to: identify recorded information while a picture or a video is being taken, wherein the picture or the video includes an image; determine whether the image contains privacy information based on the recorded information; and save the image to a storage area of TEE based on the image containing privacy information.

In an embodiment of the present disclosure, an apparatus for protecting image privacy which includes a memory and a processor is provided, wherein the memory stores one or more programs, the one or more programs including computer instructions, which, when executed by the processor, cause the processor to: identify recorded information while a picture or a video is being taken, wherein the picture or the video includes an image; determine whether the image contains privacy information based on the recorded information; and save the image to a storage area of TEE based on the image containing privacy information.

### BRIEF DESCRIPTION OF THE DRAWINGS

FIG. 1 is a flow chart of a method for protecting image privacy according to an embodiment.

FIG. 2 is a flow chart of an operation of CA on an image in a method for protecting image privacy according to an embodiment.

FIG. 3 is a flow chart of an operation of CA on an image in a method for protecting image privacy according to an embodiment.

FIG. 4 is a structural diagram of an apparatus for protecting image privacy according to an embodiment.

FIG. 5 is a structural diagram of an apparatus for protecting image privacy according to an embodiment.

FIG. 6 is a structural diagram of an apparatus for protecting image privacy according to an embodiment.

FIG. 7 is a structural diagram of an apparatus for protecting image privacy according to an embodiment.

### DETAILED DESCRIPTION

In order to clarify the objects, characteristics and advantages of the disclosure, embodiments of present disclosure will be described in detail in conjunction with accompanying drawings.

Due to a large number of shots and image recording scenarios of current products, users may not actively find some privacy-related images in time and properly handle them confidentially. In addition, more and more devices support TEE. Therefore, to ensure that images containing users' privacy do not be stolen and scanned by malicious software, embodiments of the present disclosure provide a method and apparatus for protecting image privacy, which automatically identify privacy data during an image generation process and save it in the TEE.

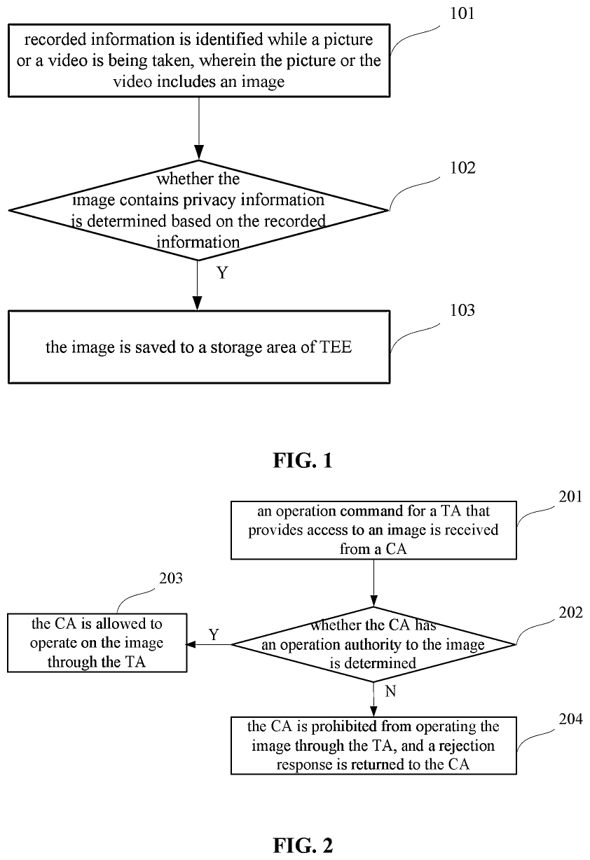

FIG. 1 is a flow chart of a method for protecting image privacy according to an embodiment. The method includes S101, S102 and S103.

In S101, recorded information is identified while a picture or a video is being taken, wherein the picture or the video includes an image.

In some embodiments, the recorded information to be identified may be determined based on one or more different application requirements, such as application environment, privacy security level, or setting information for user requirement.

In some embodiments, said identifying recorded information includes identifying a type of a recorded object, such as whether the recorded object is a person or a thing, and obtaining an object feature based on the type. For example, when the object is a person, the acquired object feature may include a local feature of human body or a clothing feature. For another example, when the object is a certificate, the acquired object feature may include a text feature, an image feature, or an identity feature.

In some embodiments, said identifying recorded information includes identifying recorded environment information, such as office environment, home environment or outdoor environment.

In some embodiments, said identifying recorded information includes identifying a type of a recorded object and a type of recorded environment.

In S102, whether the image contains privacy information is determined based on the recorded information. If the image contains privacy information, S103 is performed.

Accordingly, different methods may be used to determine whether the image contains privacy information for different recorded information. For example, a method where an environment type set by the user matches a recorded environment scenario, or a method based on a pre-trained neural network may be used. Specifically, some existing image information recognition software may be used, or privacy judgment models may be trained by acquiring image data according to different application scenarios and/or different recorded objects (such as portrait, document, or certificate), which is not limited in the embodiments of the present disclosure.

In S103, the image is saved to a storage area of TEE based on the image containing privacy information.

Generally, devices that support TEE have two operating environment including Rich Execution Environment (REE) and TEE which have independent operating systems and software. REE is responsible for running common operating systems, such as IOS or Android. Therefore, the image is saved to a storage area of REE in a normal storing manner of a recording system based on the image not containing privacy information. However, the image is saved to a storage area of TEE based on the image containing privacy information, and during this process, as the image has not been stored in the REE, a third-party program cannot read the image information, thereby ensuring security of the image containing the privacy information. In some embodiments, after it is determined that the image contains privacy information, a prompt message may be presented to prompt the user that the privacy information has been identified and security processing is performed. This prompt message can be turned off by the user. An application running in the TEE environment is referred to as Trusted Application (TA), and an application running in the REE environment is referred to as Client Application (CA). In some embodiments, a trusted CA, such as picture browsing software provided by a mobile phone, may directly use the image saved in the storage area of the TEE by calling an interface of the TA.

Further, in some cases, the above-mentioned image needs to be provided to a third-party application which is not a default trusted CA of the system. For this situation, the method for protecting image privacy in the embodiments of the present disclosure also provides a corresponding solution. Specifically, in some embodiments, the method for protecting image privacy may further include in response to an operation application request triggered by a CA for the image, controlling an operation of the CA on the image based on an operation authority of the CA on the image, so as to effectively avoid some illegal CA operations on the image.

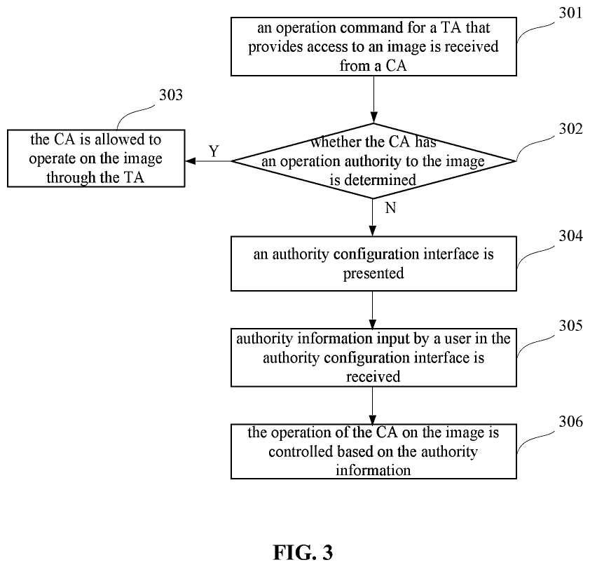

FIG. 2 is a flow chart of an operation of CA on an image in a method for protecting image privacy according to an embodiment. The operation includes S201 to S204.

In 201, an operation command for a TA that provides access to an image is received from a CA.

In 202, whether the CA has an operation authority to the image is determined; if yes, S203 is performed, otherwise, S204 is performed.

In S203, the CA is allowed to operate on the image through the TA.

In S204, the CA is prohibited from operating the image through the TA, and a rejection response is returned to the CA.

FIG. 3 is a flow chart of an operation of CA on an image in a method for protecting image privacy according to an embodiment. The operation includes S301 to S306.

In 301, an operation command for a TA that provides access to an image is received from a CA.

In 302, whether the CA has an operation authority to the image is determined; if yes, S303 is performed, otherwise, S304 is performed.

In S303, the CA is allowed to operate on the image through the TA.

In S304, an authority configuration interface is presented.

In S305, authority information input by a user in the authority configuration interface is received.

In S306, the operation of the CA on the image is controlled based on the authority information.

By presenting the authority configuration interface, the user can set the operation authority of the CA on the image based on practical requirements, which enables to meet some specific application requirements of the user under the condition of ensuring the security of privacy information.

In some embodiments, identity authentication may further be combined, that is, when the CA does not have a calling authority to the TA, not only the user determines the calling authority of the CA to the TA, but also identity authentication is performed on the user. Merely when the identity authentication is passed and the authority information entered by the user is to allow the CA to call the TA, the CA is allowed to call the TA, so that the security of the user's privacy information may be fully guaranteed. It should be noted that an existing method may be adopted for identity authentication. In addition, an order of the user's input of the authority information and the identity authentication is not limited.

Further, in some embodiments, the authority configuration information of the CA may be modified according to the authority information input by the user, so as to facilitate subsequent calling by the CA to the TA. It is also possible not to modify the authority configuration information of the CA, but to make enquiry each time the CA calls the TA. Alternatively, by asking the user whether to allow the modification of the authority configuration information of the CA, and with permission of the user, the authority configuration information of the CA is modified, so as to better protect the user's privacy information.

It should be noted that, in practice, the authority configuration information of the CA may be written into the storage area of the TEE to ensure the security of the authority configuration information and prevent some malicious applications from modification.

Further, in some embodiments, when the image is presented, the identification information corresponding to the image is also presented. The identification information is used to prompt that the image is a protected image and will not be operated by an untrusted CA. A specific form of the identification information is not limited in the embodiments of the present disclosure.

With the method for protecting image privacy provided in the embodiments of the present disclosure, a current process may be transferred to the TEE environment for processing before the image is generated, and interception of early data by malware may be prevented. In addition, for some CAs that are trusted by the system by default, images can be accessed by calling TAs. For CAs that are not trusted by the system by default, the user may be guided to make choices to ensure that merely the CAs trusted by the user are allowed to call the corresponding TAs to access the images.

Further, the authority configuration of the CA may be modified based on the authority information input by the user, so that the corresponding authority configuration of the CA can be automatically completed without the user actively opening the corresponding authority configuration interface, which facilitates the user's operation. In addition, when the CA calls the corresponding TA next time, it can be determined whether the call is allowed according to the authority configuration, which improves execution efficiency of the call under the condition of ensuring security of the call.

The method for protecting image privacy provided by the embodiments of the present disclosure may be applied to any system architecture with two operating environments of TEE and REE, for example, an ARM-based Trust Zone architecture or an AMD-based Platform Security Processor (PSP).

Accordingly, an embodiment of the present disclosure provides an apparatus for protecting image privacy. As shown in FIG. 4, the apparatus 400 includes an information identifying circuitry 401, a determining circuitry 402 and a saving circuitry 403.

The information identifying circuitry 401 is configured to identify recorded information while a picture or a video is being taken, wherein the picture or the video includes an image. The determining circuitry 402 is configured to determine whether the image contains privacy information based on the recorded information. The saving circuitry 403 is configured to save the image to a storage area of TEE based on the image containing privacy information.

With the apparatus for protecting image privacy, recorded information is identified while a picture or a video is being taken, wherein the picture or the video includes an image, whether the image contains privacy information is determined based on the recorded information, and the image is saved to a storage area of TEE based on the image containing privacy information. The record information is identified during taking the picture or video, and image data has not yet been generated at this time. Therefore, once it is found that the image contains privacy information, a current process can be transferred to the TEE environment for processing before the image is generated, which effectively prevents malware from intercepting early data.

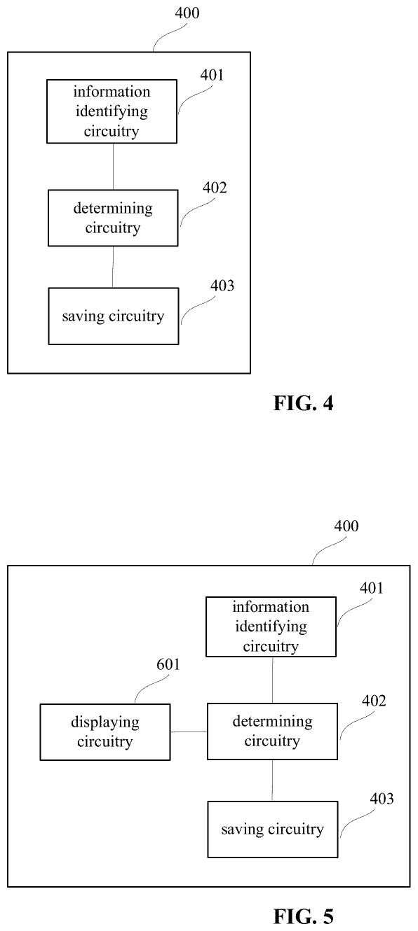

FIG. 5 is a structural diagram of an apparatus for protecting image privacy according to another embodiment.

Different from FIG. 4, the apparatus 400 in FIG. 5 further includes a displaying circuitry 601 configured to present a prompt message based on the determination circuitry 402 determines that the image contains the privacy information.

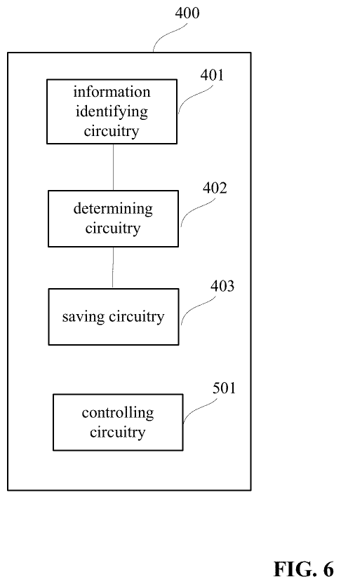

FIG. 6 is a structural diagram of an apparatus for protecting image privacy according to another embodiment.

Different from FIG. 4, the apparatus 400 in FIG. 6 further includes a controlling circuitry 501 configured to: in response to an operation application request triggered by a CA for the image, control operation of the CA on the image based on an operation authority of the CA on the image.

In some embodiments, the controlling circuitry 501 is configured to: based on the CA not having the operation authority on the image, prohibit the CA from operating the image, and return a rejection response to the CA.

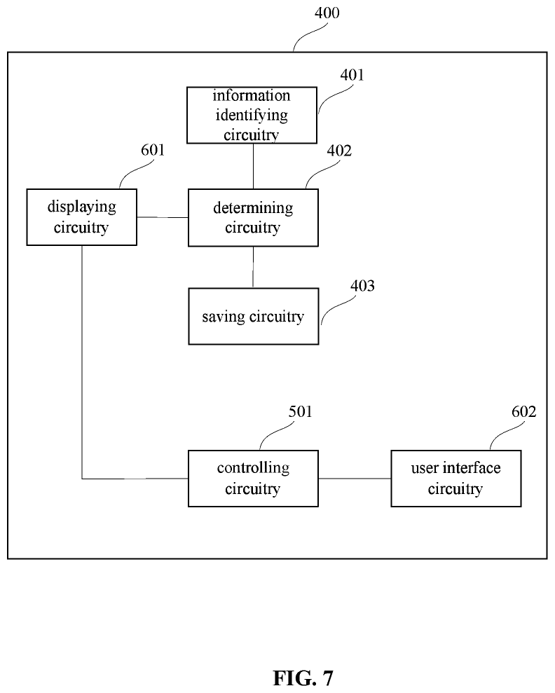

In some embodiments, the controlling circuitry 501 is configured to: based on the CA not having the operation authority on the image, control operation of the CA on the image based on the user's selection. Specifically, referring to FIG. 7, FIG. 7 is a structural diagram of an apparatus for protecting image privacy according to another embodiment.

In the embodiment, the apparatus 400 further includes a user interface circuitry 602.

In the embodiment, the controlling circuitry 501 is further configured to: based on the CA not having the operation authority on the image, control the displaying circuitry 601 to present an authority configuration interface. Accordingly, the user interface circuitry 602 is configured to receive authority information input by a user in the authority configuration interface, and the controlling circuitry 501 is further configured to control the operation of the CA on the image based on the authority information.

In some embodiments, the controlling circuitry 501 is further configured to: modify authority configuration information of the CA based on the authority information. Further, the controlling circuitry 501 is further configured to: write the authority configuration information of the CA into the storage area of the TEE.

In some embodiments, the displaying circuitry 601 is further configured to: present identification information corresponding to the image when the image is presented.

More details on working principles and working modes of the above-mentioned apparatus 400 may be referred to relevant descriptions in FIG. 1 to FIG. 3, which are not repeated here.

Accordingly, embodiments of the present disclosure further provide a terminal including the above apparatus 400 may refer to various forms of UE, access terminal, user unit, user station, Mobile Station (MS), remote station, remote terminal, mobile equipment, user terminal, terminal equipment, wireless communication equipment, user agent or user device. The terminal equipment may further be a cellular phone, a cordless phone, a Session Initiation Protocol (SIP) phone, a Wireless Local Loop (WLL) station, a Personal Digital Assistant (PDA), a handheld device with a wireless communication function, a computing device or other processing devices connected to a wireless modems, an in-vehicle device, a wearable device, a terminal equipment in the future 5G network, or a terminal equipment in a future evolved Public Land Mobile Network (PLMN), which is not limited in the embodiments of the present disclosure.

In some embodiments, the above apparatus for protecting image privacy may correspond to chips with corresponding functions in a network equipment and/or a terminal equipment, such as System-On-a-Chip (SOC), baseband chip or chip module.

In some embodiments, modules/units included in each apparatus and product described in the above embodiments may be software modules/units, hardware modules/units, or a combination of software modules/units and hardware modules/units.

For example, for each apparatus or product applied to or integrated in a chip, each module/unit included therein may be implemented by hardware such as circuits; or, at least some modules/units may be implemented by a software program running on a processor integrated inside the chip, and the remaining (if any) part of the modules/units may be implemented by hardware such as circuits. For each apparatus or product applied to or integrated in a chip module, each module/unit included therein may be implemented by hardware such as circuits. Different modules/units may be disposed in a same component (such as a chip or a circuit module) or in different components of the chip module. Or at least some modules/units may be implemented by a software program running on a processor integrated inside the chip module, and the remaining (if any) part of the modules/units may be implemented by hardware such as circuits. For each apparatus or product applied to or integrated in a terminal, each module/unit included therein may be implemented by hardware such as circuits. Different modules/units may be disposed in a same component (such as a chip or a circuit module) or in different components of the terminal. Or at least some modules/units may be implemented by a software program running on a processor integrated inside the terminal, and the remaining (if any) part of the modules/units may be implemented by hardware such as circuits.

In an embodiment of the present disclosure, a non-volatile or non-transitory computer-readable storage medium having computer instructions stored therein is provided, wherein when the computer instructions are executed by a processor, any one of the above methods is performed.

In an embodiment of the present disclosure, an apparatus for protecting image privacy which includes a memory, and a processor is provided, wherein the memory has computer instructions stored therein, and when the processor executes the computer instructions, any one of the above methods is performed.

It should be understood that the term “and/or” in the present disclosure is merely an association relationship describing associated objects, indicating that there can be three types of relationships, for example, A and/or B can represent “A exists only, both A and B exist, B exists only. In addition, the character “/” in the present disclosure represents that the former and latter associated objects have an “or” relationship.

The “plurality” in the embodiments of the present disclosure refers to two or more.

The descriptions of the first, second, etc. in the embodiments of the present disclosure are merely for illustrating and differentiating the objects, and do not represent the order or the particular limitation of the number of devices in the embodiments of the present disclosure, which do not constitute any limitation to the embodiments of the present disclosure.

The above embodiments may be implemented in whole or in part by software, hardware, firmware, or any combination thereof. When implemented in software, the above embodiments may be implemented in whole or in part in the form of a computer program product. The computer program product includes one or more computer instructions or computer programs. The procedures or functions according to the embodiments of the present disclosure are wholly or partially generated when the computer instructions or the computer programs are loaded or executed on a computer. The computer may be a general purpose computer, a special purpose computer, a computer network, or other programmable device. The computer instructions may be stored in a computer readable storage medium or transmitted from one computer readable storage medium to another computer readable storage medium, for example, the computer instructions may be transmitted from one website, computer, server or data center to another website, computer, server, or data center by wire (e.g., infrared, wireless, microwave and etc.). The computer readable storage medium may be any available medium that can be accessed by a computer or a data storage device such as a server or a data center that contains one or more sets of available media. The available medium may be a magnetic medium (e.g., floppy disk, hard disk, or magnetic tape), an optical medium (e.g., DVD), or a semiconductor medium. The semiconductor medium may be a solid disk. It should be understood that, in the various embodiments of the present disclosure, sequence numbers of the above-mentioned processes do not represent an execution sequence, and the execution sequence of each process should be determined by its function and inherent logic, which does not limit an implementation process of the embodiments of the present disclosure.

In the above embodiments of the present disclosure, it should be understood that the disclosed method, device, and system may be implemented in other ways. For example, the above device embodiments are merely illustrative, and for example, division of units is merely one logical division, and other divisions may be realized in practice, for example, a plurality of units or components may be combined or integrated into another system, or some features may be omitted, or not executed. Further, the shown or discussed mutual coupling or direct coupling or communication connection may be an indirect coupling or communication connection via some interfaces, devices, or units, and may be in an electrical, mechanical, or other form.

The units described as separate parts may or may not be physically separate, and parts shown as units may or may not be physical units, that is, may be disposed in one place, or may be distributed on a plurality of network units. Some or all of the units can be selected according to practical requirements to achieve the purpose of the solutions of the embodiments.

In addition, functional units in the embodiments of the present disclosure may be integrated in one processing unit, or each unit may be physically separate, or two or more units may be integrated in one unit. The integrated units can be realized in a form of hardware, or in a form of hardware plus a software functional unit.

Although the present disclosure has been disclosed above with reference to preferred embodiments thereof, it should be understood that the disclosure is presented by way of example only, and not limitation. Those skilled in the art can modify and vary the embodiments without departing from the spirit and scope of the present disclosure.

What is claimed is:

1. A method for protecting image privacy, comprising:
identifying recorded information while a picture or a video is being taken, wherein the picture or the video comprises an image,
determining whether the image contains privacy information based on the recorded information; and
saving the image to a storage area of Trusted Execution Environment (TEE) based on the image containing privacy information.

2. The method according to claim 1, wherein said identifying recorded information comprises:
identifying a type of a recorded object and obtaining an object feature based on the type.

3. The method according to claim 2, wherein said determining whether the image contains privacy information based on the recorded information comprises:
determining whether the image contains the privacy information based on the type and the object feature.

4. The method according to claim 3, wherein said identifying recorded information further comprises identifying recorded environment information, and
said determining whether the image contains privacy information based on the recorded information comprises determining whether the image contains privacy information based on an environment type set by a user and the recorded environment information.

5. The method according to claim 1, further comprising:
presenting a prompt message based on the image containing the privacy information.

6. The method according to claim 1, further comprising:
in response to an operation application request triggered by a Client Application (CA) for the image, controlling operation of the CA on the image based on an operation authority of the CA on the image.

7. The method according to claim 6, wherein said controlling operation of the CA on the image based on an operation authority of the CA on the image comprises:
based on the CA not having the operation authority on the image, prohibiting the CA from operating the image, and returning a rejection response to the CA.

8. The method according to claim 7, wherein said controlling operation of the CA on the image based on an operation authority of the CA on the image further comprises:
based on the CA not having the operation authority on the image, presenting an authority configuration interface,
receiving authority information input by a user in the authority configuration interface; and
controlling the operation of the CA on the image based on the authority information.

9. The method according to claim 8, further comprising:
modifying authority configuration information of the CA based on the authority information.

10. The method according to claim 9, further comprising:
writing the authority configuration information of the CA into the storage area of the TEE.

11. The method according to claim 6, further comprising:
presenting identification information corresponding to the image when the image is presented.

12. The method according to claim 11, wherein identification information is used to prompt that the image is a protected image.

13. A non-volatile or non-transitory computer-readable storage medium storing one or more programs, the one or more programs comprising computer instructions, which, when executed by a processor, cause the processor to:
identify recorded information while a picture or a video is being taken, wherein the picture or the video comprises an image,
determine whether the age contains privacy information based on the recorded information; and
save the image to a storage area of Trusted Execution Environment (TEE) based on the image containing privacy information.

14. The non-volatile or non-transitory computer-readable storage medium according to claim 13, wherein said identifying recorded information comprises:
identifying a type of a recorded object and obtaining an object feature based on the type.

15. The non-volatile or non-transitory computer-readable storage medium according to claim 14, wherein said determining whether the image contains privacy information based on the recorded information comprises:
determining whether the image contains the privacy information based on the type and the object feature.

16. The non-volatile or non-transitory computer-readable storage medium according to claim 15, wherein said identifying recorded information further comprises identifying recorded environment information, and
said determining whether the image contains privacy information based on the recorded information comprises determining whether the image contains privacy information based on an environment type set by a user and the recorded environment information.

17. The non-volatile or non-transitory computer-readable storage medium according to claim 13, wherein the processor is further caused to:
present a prompt message based on the image containing the privacy information.

18. The non-volatile or non-transitory computer-readable storage medium according to claim 13, wherein the processor is further caused to:
in response to an operation application request triggered by a Client Application for the image, control operation of the CA on the image based on an operation authority of the CA on the image.

19. The non-volatile or non-transitory computer-readable storage medium according to claim 18, wherein said controlling operation of the CA on the image based on an operation authority of the CA on the image comprises:
based on the CA not having the operation authority on the image, prohibiting the CA from operating age, and returning a rejection response to the CA.

20. An apparatus for protecting image privacy, comprising a memory and a processor, wherein the memory stores one or more programs, the one or more programs comprising computer instructions, which, when executed by the processor, cause the processor to:
identify recorded information while a picture or a video is being taken, wherein the picture or the video comprises an image,
determine whether the image contains privacy information based on the recorded information; and
save the image to a storage area of TEE based on the image containing privacy information.
